(19) United States
(12) Patent Application Publication
(10) Pub. No.: US 2006/0198301 A1
(43) Pub. Date: Sep. 7, 2006

(54) Packet-level service differentiation for quality of service provisioning over wireless local area networks

(75) Inventors: Manish Airy, Austin, TX (US); Harshal S. Chhaya, Plano, TX (US); Ariton Xhafa, Plano, TX (US); Xiaolin Lu, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/074,359

(22) Filed: Mar. 7, 2005

(51) Int. Cl. H04J 3/14; H04J 1/16; H04L 1/00; H04L 12/26; H04L 12/28; H04L 12/66

(52) U.S. Cl. 370/229; 370/352

(57) ABSTRACT

The present invention provides a packet prioritizer for use with a wireless local area network (WLAN) access point. In one embodiment, the packet prioritizer includes a priority tagger configured to provide a packet priority for a WLAN packet. Additionally, the packet prioritizer also includes a priority scheduler coupled to the priority tagger and configured to provide a strict priority scheduling of the WLAN packet through the WLAN access point based on the packet priority.

### TECHNICAL FIELD OF THE INVENTION

The present invention is directed, in general, to a communications system and, more specifically, to a packet prioritizer, a method of packet prioritizing and a wireless local area network (WLAN) access point employing the prioritizer or the method.

### BACKGROUND OF THE INVENTION

The increase in mobile end-user devices and corresponding applications continues to drive an increased demand for wireless access to wired networks such as the Internet. The WLAN accomplishes this by providing a shared broadcast medium wherein wireless end-user devices must time-share airtime that is controlled by a single access point. This may be contrasted to a cellular telephone network wherein enough resources exist to dedicate an entire connection path to a single telephone call. The shared broadcast medium of the WLAN requires that packets of information from multiple end-user devices be scheduled for transmission by the access point.

Various applications have different transmission timing requirements in order to provide a needed quality of service. The IEEE802.11e specification provides a quality of service control protocol that enables a service differentiation to be provided for packets. The existing service differentiation provides only a statistical guarantee to different types of packet traffic that shares the medium. For example, voice and e-mail traffic require different quality of service levels to provide acceptable service quality. In particular, voice packets need to be delivered within strict delay bounds whereas e-mail packets are delay tolerant.

Currently, access points allow a “flow-level” connection establishment phase where priority information for a particular flow is explicitly exchanged. Scheduling of packets for transmission employs a statistical scheduling technique. Following a channel idle detect, the statistical scheduling takes the form of generating a uniform random number between zero and an upper limit that is a function of a priority class. Higher priority packets have lower upper limits, and lower priority packets have higher upper limits. Each priority class that has a packet to transmit generates a random number, and the priority class with the lowest generated random number transmits next.

The statistical scheduling algorithm may allow “priority inversion”. In other words, for a given priority node a lower priority packet may be transmitted even when higher priority packets are present. It can be shown mathematically that in a heavily loaded system, with statistical scheduling, a given node with high priority packets will be starved of transmission with a probability of one, even if all other nodes have lower priority packets.

The transmission parameters employed for packet scheduling are determined at a point in time for a given channel loading condition. For example, the transmission parameters may be set for an anticipated average traffic loading condition and then remain constant for all traffic loading conditions. If the traffic loading condition varies significantly thereby preventing a single set of transmission parameters from providing effective overall operation, throughput performance of the access point will typically be severely degraded.

Accordingly, what is needed in the art is an enhanced way to manage packet priority in a WLAN system especially during changing traffic load conditions.

### SUMMARY OF THE INVENTION

To address the above-discussed deficiencies of the prior art, the present invention provides a packet prioritizer for use with a wireless local area network (WLAN) access point. In one embodiment, the packet prioritizer includes a priority tagger configured to provide a packet priority for a WLAN packet. Additionally, the packet prioritizer also includes a priority scheduler coupled to the priority tagger and configured to provide a strict priority scheduling of the WLAN packet through the WLAN access point based on the packet priority.

In another aspect, the present invention provides a method of packet prioritizing for use with a wireless local area network (WLAN) access point. The method includes providing a packet priority for a WLAN packet, and further providing a strict priority scheduling of the WLAN packet through the WLAN access point based on the packet priority.

The present invention also provides, in yet another aspect, an access point for use with a wireless local area network (WLAN). The access point includes a wired interface section coupled to a wired network, a wireless interface section wirelessly coupled to multiple end-user devices and a packet prioritizer coupled to the wired and wireless interface sections. The packet prioritizer has a priority tagger that provides a packet priority for a WLAN packet and a priority scheduler, coupled to the priority tagger, that provides a strict priority scheduling of the WLAN packet through the access point based on the packet priority.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of a communications network employing a wireless local area network (WLAN) that is constructed in accordance with the principles of the present invention;

FIG. 2 illustrates a block diagram of a WLAN access point constructed in accordance with the principles of the present invention; and

FIG. 3 illustrates a flow diagram of an embodiment of a method of packet prioritizing carried out in accordance with the principles of the present invention.

### DETAILED DESCRIPTION

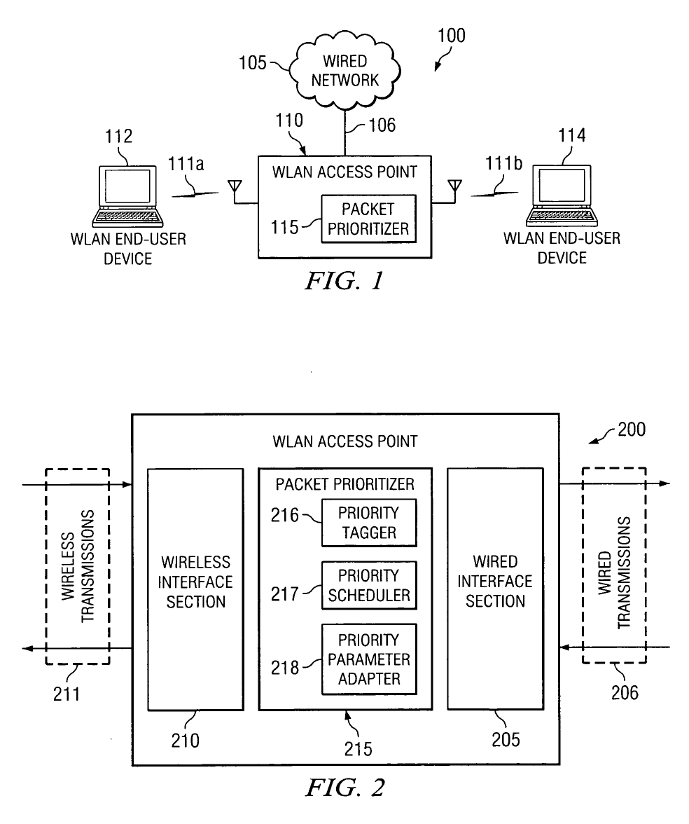

Referring initially to FIG. 1, illustrated is a system diagram of an embodiment of a communications network, generally designated 100, employing a wireless local area network (WLAN) that is constructed in accordance with the principles of the present invention. The communications network 100 includes a wired network 105 and a WLAN access point 110 having first and second WLAN end-user devices 112, 114. The WLAN access point 110 employs a wired coupling 106 to the wired network 105 and first and second wireless couplings 111a, 111b to the first and second WLAN end-user devices 112, 114, as shown. The WLAN access point 110 includes a packet prioritizer 115 that provides priority tagging and transmission scheduling of WLAN packets associated with the first and second WLAN end-user devices 112, 114.

The WLAN access point 110 provides a shared broadcast channel to the first and second WLAN end-user devices 112, 114 wherein airtime is a shared resource between the two. The first and second WLAN end-user devices 112, 114 may typically employ a range of applications having different quality of service requirements. These applications may include voice, video, music downloads, HTTP sessions, web browsing or e-mail to list a few possibilities. Voice applications may require transmissions that are close to real time, while e-mail could accommodate larger transmission delays without appreciably affecting quality of service.

The packet prioritizer 115 includes a priority tagger that provides a packet priority for each of the WLAN packets; and a priority scheduler, coupled to the priority tagger, that provides a strict priority scheduling of the WLAN packets through the WLAN access point 110 based on the packet priority. The strict priority scheduling consistently schedules a higher priority WLAN packet ahead of a lower priority WLAN packet through the WLAN access point 110.

In the illustrated embodiment, the packet prioritizer 115 also includes a priority parameter adapter that adapts at least one operation-specific parameter for the packet priority based on a channel loading condition of the WLAN access point 110. The operation-specific parameters include an inactive packet priority category, an arbitration interframe spacing, a minimum contention window and a maximum contention window.

Turning now to FIG. 2, illustrated is a block diagram of a WLAN access point, generally designated 200, constructed in accordance with the principles of the present invention. The WLAN access point 200 includes a wired interface section 205, a wireless interface section 210 and a packet prioritizer 215 that is coupled to the wired and wireless interface sections 205, 210. The wired interface section 205 accommodates wired transmissions 206 with a wired network, and the wireless interface section 210 accommodates wireless transmissions 211 with WLAN end-user devices that send and receive WLAN packets.

The packet prioritizer 215 includes a priority tagger 216, a priority scheduler 217 and a priority parameter adapter 218. The priority tagger 216 provides a packet priority for each of the WLAN packets that is processed by the WLAN access point 200. In the illustrated embodiment, the priority tagger 216 inspects a datagram associated with the WLAN packet and extracts a service destination port address from within the datagram. The priority tagger 216 also maps the service destination port address to a specific priority access category. The WLAN access point 200 employs up to eight priority access categories, which conform to the IEEE 802.11e standard and establish packet priority categories.

Additionally, the priority tagger 216 sets a tag in a media access control (MAC) header associated with the WLAN access point 200, which provides the packet priority based on the service destination port address. The tag conforms to the IEEE 802.1D MAC bridge specification. By using service destination port numbers, the mapping establishes a well-defined notion of a “flow” and hence establishes a procedure for packet-level application differentiation.

Over the shared channel afforded by the WLAN access point 200 employing multiple nodes and heterogeneous applications, the priority tagger 216 provides a uniform mapping method to differentiate these applications. Additionally, the priority tagger 216 ensures that packet-level differentiation is accurate and reflects the requirements of the source application.

The priority scheduler 217 is coupled to the priority tagger 216 and provides a strict priority scheduling of the WLAN packets through the WLAN access point 200 based on the packet priority associated with each WLAN packet. The strict priority scheduling employed by the priority scheduler 217 ensures that the transmission of all higher priority packets is accomplished before lower priority packets are transmitted. This priority scheduling achieves a quality of service differentiation for each packet priority.

Strict priority scheduling prevents transmission starving of high priority packets by reserving the medium for higher priority packets. This is accomplished by setting lower defer times, following a channel idle detect, for higher priority packets thereby ensuring that lower priority packets defer contending for the medium. In other words, higher priority packets only contend with each other and not with lower priority packets.

The priority scheduler 217 employs specific parameters associated with each priority access category to ensure that a packet tagged with the highest priority is selected first for transmission. Since channel loading conditions of the WLAN access point 200 typically change over time, the specific parameters selected at a particular time may not reflect the priority loading requirements of the WLAN access point 200 at a later time. Therefore, the parameters are operation-specific in that they depend on the channel loading conditions.

The priority parameter adapter 218 is coupled to the priority scheduler 217 and is configured to adapt at least one of the operation-specific parameters associated with the packet priorities based on the channel loading condition. These access category specific parameters include an inactive packet priority category, an arbitration interframe spacing (AIFS), a minimum contention window (CW_{MIN}) and a maximum contention window (CW_{MAX}).

The WLAN access point 200 maintains an estimate of the channel loading condition (measured as the number of WLAN packets per second) per packet priority category xₚ, where p is the priority category index associated with the transmission medium and a number of active priority categories over a suitable time interval. Based on these measurements, the WLAN access point 200 jointly determines AIFS and CW_{MIN} values for all packet priority categories and broadcasts these new values during the next beacon. Generally, this parameter adaptation is accomplished every T seconds, which corresponds to a measurement window.

If a particular priority class p is inactive over the last measurement window T, then priority categories q>p are treated as priority categories q−1, where q is a lower priority category than p. The priority parameter adapter 218 determines the following for each active priority class:
CW_{MIN}_{ₚ}=Kxₚ/M, (1)
AIFS₀=0, and (2)
AIFS_{q}=ΣAIFSₚ+CW_{MIN}_{ₚ}. (3)
The term K is a constant greater than one indicating an increase in the number of access attempts due to detectable collisions. Note that the packet priority category xₚ indicates the number of access attempts per second. Each successful WLAN packet is associated with exactly one access attempt, if there are no collisions. The term M represents the number of unused transmission slots, averaged over one second. In other words, the optimal CW_{MIN}_{ₚ} is set so that there is, on average, one attempt per transmission slot. Note the choice of AIFS, which assures all higher priority packets are transmitted before any lower priority packet. Finally, in the absence of higher priority packets, the medium is entirely available to lower priority packets with CW_{MIN} set to maximize throughput.

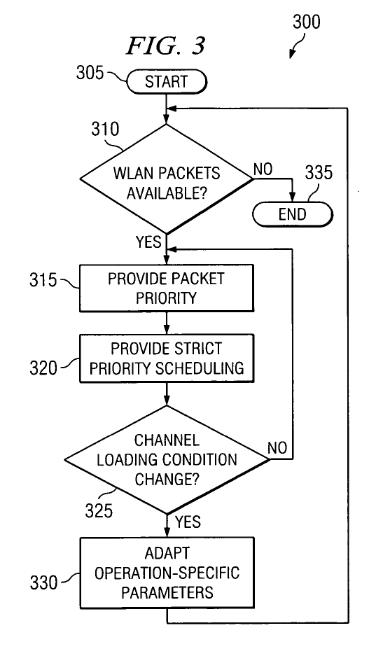

Turning now to FIG. 3, illustrated is a flow diagram of an embodiment of a method of packet prioritizing, generally designated 300, carried out in accordance with the principles of the present invention. The method 300 is for use with a WLAN access point and starts in a step 305. Then in a first decisional step 310 it is determined if various WLAN packets requiring different transmission priorities to achieve a desired quality of service are present for transmission by the WLAN access point.

If such packets are available in the first decisional step 310, a packet priority is provided for each WLAN packet in a step 315. In the illustrated embodiment, the step 315 includes inspecting a datagram associated with the WLAN packet, extracting a service destination port address from within the datagram, mapping the service destination port address to a specific priority access category, and setting a tag in a media access control (MAC) header to provide the packet priority based on the service destination port address. The specific priority access categories conform to the IEEE 802.11e standard, and the tag in the MAC header conforms to the IEEE 802.1D MAC bridge specification.

In a step 320, a strict priority scheduling is provided for the WLAN packets through the WLAN access point based on the packet priority provided in the step 315. This strict priority scheduling always schedules WLAN packets for transmission with higher priorities ahead of lower priority WLAN packets thereby assuring that high priority WLAN packets only compete with other high priority WLAN packets for transmission. This avoids the problem of high priority packets being starved of transmission even when all other WLAN packets have lower packet priorities.

In the illustrated embodiment, there are eight specific priority access categories wherein each of the categories may accommodate a different class or level of packet priority associated with the WLAN packets. There are also operation-specific parameters associated with each of the specific priority access categories that facilitate the strict priority scheduling. These parameters may include arbitration interframe spaces, minimum contention windows and maximum contention windows as well as the specific priority access categories that have been inactive during a measurement window.

In a second decisional step 325, it is determined if a change has occurred in a channel loading condition associated with the transmission traffic through the WLAN access point during the measurement window. This loading condition may encompass an increase or decrease in the total amount of transmission traffic. Alternatively, the loading condition change may also encompass differences in the priority loading of the WLAN access point thereby shifting the spectrum of priorities associated with the WLAN packets even though the overall channel loading may remain substantially unchanged.

If a change in the channel loading condition is not indicated in the second decisional step 325, the method 300 returns to the step 315 wherein packet priorities continue to be provided, and strict priority scheduling continues in the step 320 with operation-specific parameters that are unchanged. Alternatively, if the channel loading condition of the WLAN access point has changed, the operation-specific parameters are appropriately adapted to the new channel loading condition in a step 330.

Then, the method 300 returns to the first decisional step 310 and if it is determined that WLAN packets continue to be available for transmission, the method 300 continues as before employing the adapted operation-specific parameters from the step 330. If it is determined in the first decisional step 310 that multiple-priority WLAN packets are not available for transmission, the method 300 ends in a step 335.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

In summary, embodiments of the present invention employing a packet prioritizer, a method of packet prioritizing and a WLAN access point employing the prioritizer or the method have been presented. Advantages include priority tagging based on service destination port addresses thereby allowing strict priority scheduling of WLAN packets. This strict priority scheduling assures that all higher priority WLAN packets are always afforded transmission priority over lower priority WLAN packets. Additionally, the scheduling parameters employed for strict priority scheduling may be adapted to accommodate varying channel loading conditions. This adaptation maintains a more optimum throughput for the WLAN access point than would typically be afforded by fixed priority parameters.

Although the present invention has been described in detail, those skilled in the art should understand that they can make various changes, substitutions and alterations herein without departing from the spirit and scope of the invention in its broadest form.

What is claimed is:

1. A packet prioritizer for use with a wireless local area network (WLAN) access point, comprising:
a priority tagger configured to provide a packet priority for a WLAN packet; and
a priority scheduler coupled to said priority tagger and configured to provide a strict priority scheduling of said WLAN packet through said WLAN access point based on said packet priority.

2. The packet prioritizer as recited in claim 1 wherein said priority tagger is configured to inspect a datagram associated with said WLAN packet, extract a service destination port address from within said datagram, map said service destination port address to a specific priority access category and set a tag in a media access control (MAC) header to provide said packet priority based on said service destination port address.

3. The packet prioritizer as recited in claim 2 wherein said specific priority access category conforms to the IEEE 802.11e standard.

4. The packet prioritizer as recited in claim 2 wherein said tag conforms to the IEEE 802.1D MAC bridge specification.

5. The packet prioritizer as recited in claim 1 wherein said strict priority scheduling consistently schedules a higher priority WLAN packet ahead of a lower priority WLAN packet through said WLAN access point.

6. The packet prioritizer as recited in claim 1 wherein said strict priority scheduling sets lower defer times for higher priority WLAN packets following a channel idle detect.

7. The packet prioritizer as recited in claim 1 further comprising a priority parameter adapter configured to adapt at least one operation-specific parameter for said packet priority based on a channel loading condition of said WLAN access point.

8. The packet prioritizer as recited in claim 7 wherein said at least one operation-specific parameter is selected from the group consisting of:
an inactive packet priority category;
an arbitration interframe spacing;
a minimum contention window; and
a maximum contention window.

9. A method of packet prioritizing for use with a wireless local area network (WLAN) access point, comprising:
providing a packet priority for a WLAN packet; and
further providing a strict priority scheduling of said WLAN packet through said WLAN access point based on said packet priority.

10. The method as recited in claim 9 wherein said providing includes:
inspecting a datagram associated with said WLAN packet, extracting a service destination port address from within said datagram,
mapping said service destination port address to a specific priority access category, and
setting a tag in a media access control (MAC) header to provide said packet priority based on said service destination port address.

11. The method as recited in claim 10 wherein said specific priority access category conforms to the IEEE 802.11e standard.

12. The method as recited in claim 10 wherein said tag conforms to the IEEE 802.1D MAC bridge specification.

13. The method as recited in claim 9 wherein said strict priority scheduling consistently schedules a higher priority WLAN packet ahead of a lower priority WLAN packet through said WLAN access point.

14. The method as recited in claim 9 wherein said strict priority scheduling sets lower defer times for higher priority WLAN packets following a channel idle detect.

15. The method as recited in claim 9 further comprising adapting at least one operation-specific parameter for said packet priority based on a channel loading condition of said WLAN access point.

16. The method as recited in claim 15 wherein said at least one operation-specific parameter is selected from the group consisting of:
an inactive packet priority category;
an arbitration interframe spacing;
a minimum contention window; and
a maximum contention window.

17. An access point for use with a wireless local area network (WLAN), comprising:
a wired interface section coupled to a wired network;
a wireless interface section wirelessly coupled to multiple end-user devices; and
a packet prioritizer coupled to said wired and wireless interface sections, including:
a priority tagger that provides a packet priority for a WLAN packet; and
a priority scheduler, coupled to said priority tagger, that provides a strict priority scheduling of said WLAN packet through said access point based on said packet priority.

18. The access point as recited in claim 17 wherein said priority tagger inspects a datagram associated with said WLAN packet, extracts a service destination port address from within said datagram, maps said service destination port address to a specific priority access category and sets a tag in a media access control (MAC) header to provide said packet priority based on said service destination port address.

19. The access point as recited in claim 18 wherein said specific priority access category conforms to the IEEE 802.11e standard.

20. The access point as recited in claim 18 wherein said tag conforms to the IEEE 802.1D MAC bridge specification.

21. The access point as recited in claim 17 wherein said strict priority scheduling consistently schedules a higher priority WLAN packet ahead of a lower priority WLAN packet through said WLAN access point.

22. The access point as recited in claim 17 wherein said priority scheduler sets lower defer times for higher priority WLAN packets following a channel idle detect.

23. The access point as recited in claim 17 further comprising a priority parameter adapter that adapts at least one operation-specific parameter for said packet priority based on a channel loading condition of said access point.

24. The access point as recited in claim 23 wherein said at least one operation-specific parameter is selected from the group consisting of:
an inactive packet priority category;
an arbitration interframe spacing;
a minimum contention window; and
a maximum contention window.
